(19) United States
(12) Patent Application Publication
(10) Pub. No.: US 2026/0226769 A1
(43) Pub. Date: Aug. 6, 2026

(54) MOTORIZED LATCH RETRACTION ASSEMBLY AND MOUNTING BRACKET FOR THE SAME

(71) Applicant: Hanchett Entry Systems, Inc., Phoenix, AZ (US)

(72) Inventors: Gerardo Alvarez Tostado Saucedo, Chapala (MX); Trace Benjamin Morgan, Scottsdale, AZ (US); Eyan Kurtis Osborn, Phoenix, AZ (US); Larry Gene Corwin, JR., Phoenix, AZ (US); Brendan Webb, Gilbert, AZ (US)

(73) Assignee: Hanchett Entry Systems, Inc., Phoenix, AZ (US)

(21) Appl. No.: 19/448,952

(22) Filed: Jan. 14, 2026

Related U.S. Application Data
(60) Provisional application No. 63/754,072, filed on Feb. 5, 2025.

(51) Int. Cl. E05B 47/00; E05B 47/02

(52) U.S. Cl. CPC E05B 47/0012; E05B 47/02; E05B 2047/0017; E05B 2047/002

(57) ABSTRACT

A motorized latch retraction assembly for installation within a door latch system is provided. The motorized latch retraction assembly comprising an electromechanical actuator, a gear assembly, and a rack and pinion drive mechanism. The gear assembly includes first and second gears. The first gear is operably coupled to the electromechanical actuator and the second gear. The rack and pinion drive mechanism includes a drive arm and a pinion gear. The drive arm defines a rack member and is configured to be operably coupled to the actuating assembly. The pinion gear includes a pinion shaft operably coupled to the second gear. The pinion gear further includes a rack gear operably coupled to the rack member. The electromechanical actuator operates the gear assembly and the pinion gear to move the drive arm in a linear direction such that the actuation assembly moves the latch between the extended position and the retracted position.

### CROSS-REFERENCE TO RELATED APPLICATIONS

This application claims the benefit of U.S. Patent Application No. 63/754,072, filed on Feb. 5, 2025, the contents of which are incorporated by reference in its entirety.

### TECHNICAL FIELD

The present invention relates to a push bar door latch system for selectively securing a hinged door to a door frame; more particularly, to motorized latch retraction assembly for use with a push bar door latch system that is configured to automatically retract a latch from a corresponding strike upon the initiation of a door unlatching signal via applied power; and still more particularly to a compact motorized latch retraction assembly configured to automatically retract the latch from the strike, hold the latch in a retracted position while at the same time conserving energy, and enable the latch to be moved back to an extended position upon the occurrence of a power interruption. A mounting bracket for securing the motorized latch retraction assembly is also provided.

### BACKGROUND OF THE INVENTION

Existing push bar exit devices typically include a latch mechanism that is used to selectively secure a door to a door frame, which may be, for example, a Pullman style latch mechanism, a latch mechanism having a latch in the shape of a starwheel, a surface vertical rod latch mechanism, a concealed vertical rod latch mechanism, or a mortise style latch mechanism. The latch operates to rotate or otherwise retract out of a door strike to allow the door to be opened relative to the door frame. It should be understood that the latch may be mounted in the door and the strike may be mounted in the door frame, or vice versa, to equal effect. The latch may be disposed adjacent a side edge of the door and/or a top or bottom edge of the door.

Push bar exit devices further include what is commonly referred to as a panic bar (generally referred to herein as a “push bar”) that is used to manually actuate a series of linkages to retract the latch from the strike to enable door opening. Push bars allow users to open the door without necessarily requiring the use of their hands. Rather, the user's body or other object can be used to push against the push bar until the latch is retracted from the strike.

In some cases, it may be desirable for a push bar exit device that only allows for retraction of the latch through manual actuation of the push bar to be modified or retrofitted to allow for the automatic retraction of the latch upon the occurrence of a door unlocking signal. Such a door unlocking signal may be generated by a user presenting an authorized credential (e.g., key card, key fob) to a door security device associated with the exit device, a fire alarm, or a command that requires the door be left in a dogged position for a period of time. In such cases, exit devices may be retrofitted to include an electric actuator and associated components (“retrofit systems”) that, upon supplying current to the actuator, the latch is automatically retracted from the strike without requiring manual actuation of the push bar.

While push bar exit devices may be modified to include a retrofit system for automatically retracting the latch in response to an unlocking signal, there are drawbacks with these existing systems. For example, in order to securely mount certain retrofit systems, it is necessary to pre-drill holes in the existing housing of the push bar exit device which requires tools and a series of measurements to ensure that the retrofit system will align and interact properly with the existing linkages of the push bar exit assembly to allow for the retraction of the latch. Further, the number and type of components that are required for the retrofit systems to interact with the existing linkages of the push bar exit assembly make it difficult for the retrofit systems to fit within push bar exit assemblies that have smaller housings. Existing retrofit systems are therefore only able to be used in certain use cases. Moreover, the actuators used in these retrofit systems are configured in such a way that not only requires power be provided to the actuator to automatically move the latch to a retracted position, but to also hold the latch in the retracted position. This requires a significant amount of energy when it is desired to dog the latch in the retracted position which is not desirable. Furthermore, if there is a power failure when the latch is in the retracted position, the bias force provided by the springs in the components that make up the manual actuation system will operate to move the latch to the extended position to secure the latch within the strike and secure the door within the door frame.

Therefore, what is needed is a push bar door latch system that can easily be retrofitted to existing push bar exit devices, reduces power consumption when the latch is in the retracted or dogged position. It is an aspect of the present invention to address these, as well as other, needs.

### SUMMARY OF THE INVENTION

Briefly described, a motorized latch retraction assembly for installation within a push bar door latch system is provided. The door latch system includes an actuating assembly for selectively moving a latch between an extended position and a retracted position for releasably securing a door in a door frame. The motorized latch retraction assembly comprises an electromechanical actuator configured for selectively receiving power from a power supply, a gear assembly, and a rack and pinion drive mechanism. The gear assembly includes a first gear and a second gear, wherein the first gear is operably coupled to the electromechanical actuator, and wherein the first gear is operably connected to the second gear. The rack and pinion drive mechanism includes a drive arm and a pinion gear. The drive arm defines a rack member, wherein the drive arm configured to be operably coupled to the actuating assembly. The pinion gear includes a pinion shaft operably coupled to the second gear. The pinion gear further includes a rack gear operably coupled to the rack member. When power is provided to the electromechanical actuator by the power supply, the electromechanical actuator operates the gear assembly and the pinion gear to move the drive arm in a linear direction such that the actuation assembly moves the latch between the extended position and the retracted position. Further, the drive arm is configured to decouple from the actuating mechanism during manual actuation of the actuating assembly. In one embodiment, the drive arm includes a first engagement arm and a second engagement arm. The actuating mechanism includes a shaft having a first end and a second end, wherein the first engagement arm is configured to be engaged with the first end of the shaft and the second engagement arm is configured to engage the second end of the shaft when the drive arm moves in the linear direction to move the latch between the extended position and the retracted position.

The motorized latch retraction assembly may further comprise a carrier link, a micro switch, and a Hall Effect sensor. The carrier link is fixedly coupled to the actuating assembly and movably mounted to the electromechanical actuator. Further, the carrier link may move independently relative to the drive arm. The micro switch selectively interacts with the carrier link and is configured for determining when the actuating assembly is in a position indicative of the latch being in at least one of the retracted position or the extended position. The Hall Effect sensor is associated with the carrier link, wherein when power is supplied to the electromechanical actuator the Hall Effect sensor determines when the latch has been moved to the retracted position so that the power from the power supply is cut off to the electromechanical actuator. Further, the electromechanical actuator may be a motor that does not back drive after moving the latch to the retracted position and power is cut off to the electromechanical actuator from the power supply.

The motorized latch retraction assembly may further comprise a capacitor. After the latch is moved to the retracted position and power is cut off to the electromechanical actuator from the power supply, the capacitor operates to supply power to the electromechanical actuator to move the latch to the extended position. The actuating mechanism may further include a biasing mechanism, wherein a force is imposed by the biasing mechanism along with the power provided by the capacitor operate to move the latch to the extended position after power is cut off to the electromechanical actuator from the power supply.

In another aspect, a mounting bracket for mounting a motorized latch retraction assembly within a housing of a door latch system is provided. The housing includes a cavity defined by a first side wall, a second side wall, and a bottom wall disposed between the first side wall and the second side wall, and a housing width extends between the first side wall and the second side wall. The motorized latch assembly includes a mounting location. In one embodiment, the mounting bracket comprises a positioning component configured to be rotatably mounted to the motorized latch retraction assembly, and a clamping plate having a width and fixedly coupled to the positioning component. The clamping plate includes a base section and at least one flange extending from the base section, wherein a respective gap is defined between the base section and the at least one flange. For example, at least one flange may be first and second flanges that extend from opposite sides of the base section, wherein the clamping plate as a first plate width in a first state, wherein the first plate width is greater than the housing width. The first plate width may extend between outer surfaces of the first and second flanges. The positioning component is configured to move the clamping plate between a first rotational position and a second rotational position. When the clamping plate is in the first rotational position and the first state, the motorized latch assembly is able to be placed within the cavity. When the clamping plate is in the second rotational position, second state when in the engaged position, the clamping plate is configured to be placed in a second state wherein the at least one flange is in contact and engaged with the housing so that the clamping plate has a second plate width that is less than the first plate width whereby the motorized latch retraction assembly is securably mounted within the cavity of the housing. The second plate width may be equal to the housing width.

Further, the positioning component may comprise a shaft including a flanged end portion, wherein the shaft is rotatably mounted to the motorized latch retraction assembly. Further, the clamping plate may include a recess defined therein, wherein the flanged end portion of the positioning component is configured for being nested in the recess. The recess may be, for example, a non-circular shape. Also, the shaft of the positioning component may include a threaded bore defined therein with an open end, wherein the mounting bracket further includes a set screw configured for being threadably engaged with and positioned within the threaded bore. The set screw may be configured for selectively extending a distance beyond the open end to contact the bottom wall of housing to further secure the mounting bracket, and therefore the motorized latch retraction assembly, to the housing.

In another aspect, method of mounting a motorized latch retraction assembly within a housing of a door latch system. The method comprises: a) providing a mounting bracket including: i) a positioning component configured to be rotatably mounted to the motorized latch retraction assembly; and ii) a clamping plate fixedly coupled to the positioning component, wherein the clamping plate includes a base section and at least one flange, wherein the clamping plate has a first plate width in a first state, wherein the first plate width is greater than the housing width, such as first and second flanges, extending from the base section, wherein a respective gap is defined between the base section and the at least one flange, wherein the positioning component is configured to move the clamping plate between a first rotational position and a second rotational position; b) disposing the motorized latch retraction assembly and the mounting bracket in the cavity when the clamping plate is in the first rotational position and in the first state so that the clamping plate is positioned adjacent to the bottom wall of the housing; and c) rotating the positioning component relative to motorized latch retraction assembly to place the clamping plate in the second rotational position and a second state such that the at least one flange is in contact and engaged with the housing, wherein when the clamping plate is in the second state the clamping plate has a second plate width that is less than the first plate width to securably mount the motorized latch assembly in the housing. When the clamping plate moves from the first state to the second state, the at least one flange may operate to flex inwardly toward the base section to provide an outward bias force against the housing.

In the instance that first and second flanges are included, when the clamping plate is in the second state, the first flange is in contact and engaged with the first side wall and the second flange is in contact and engaged with the second side wall. Further, the positioning member may comprise a shaft that includes a threaded bore defined therein with an open end, the mounting bracket may further include a set screw configured for being threadably engaged with and positioned within the threaded bore, the first side wall includes a first nodule extending into the cavity, and the second side wall includes a second nodule extending into the cavity. The method may further comprise the step of positioning the set screw so that the set screw contacts the bottom wall of housing and extends a distance outwardly from the open end of the shaft so that the first flange engages the first nodule and the second flange engages the second nodule when the clamping plate is in the second rotational position to securably mount the motorized latch assembly in the housing.

In another embodiment, the mounting bracket comprises a positioning component rotatably mounted to the motorized latch retraction assembly, wherein the positioning member comprises a shaft including a threaded bore defined therein including an open end. The mounting bracket may further include a set screw configured for being threadably engaged with and positioned within the threaded bore, wherein the set screw is configured to extend a distance outwardly from the open end of the shaft to contact the bottom wall of a housing. The mounting bracket may further include a clamping plate fixedly coupled to the positioning component. The positioning component is configured to move the clamping plate between a first rotational position and a second rotational position. When the clamping plate is in the first rotational position, the motorized latch assembly is able to be placed within a cavity. When the clamping plate is in the second rotational position and set screw is extended the distance outwardly from the open end of the shaft to contact the bottom wall of the housing, the clamping plate is engaged with at least one nodule extending into the cavity so that the motorized latch retraction assembly is securably mounted within the cavity of the housing.

In a further embodiment, a method of mounting a motorized latch retraction assembly within a housing of a door latch system is provided. The method comprises: a) providing a mounting bracket including: i) a positioning component configured to be rotatably mounted to the motorized latch retraction assembly, wherein the positioning member comprises a shaft including a threaded bore defined therein including an open end; ii) a set screw configured for being threadably engaged with and positioned within the threaded bore, wherein the set screw is configured to extend a distance outwardly from the open end of the shaft to contact the bottom wall of the housing, iii) a clamping plate fixedly coupled to the positioning component, wherein the positioning component is configured to move the clamping plate between a first rotational position and a second rotational position; b) disposing the motorized latch retraction assembly and the mounting bracket in a cavity when the clamping plate is in the first rotational position so that the clamping plate is positioned adjacent to the bottom wall of the housing; c) rotating the positioning component relative to motorized latch retraction assembly to place the clamping plate in the second rotational position; and d) extending set screw a distance outwardly from the open end of the shaft to contact the bottom wall of the housing and place the clamping plate in engagement with at least one nodule extending into the cavity to securably mount the motorized latch assembly in the housing.

In still another embodiment, the mounting bracket comprises a base plate, a clamping plate, at least one standoff, and a corresponding number of fasteners. The base plate includes a first surface and a second surface. Each standoff includes a post extending from the second surface of the base plate, wherein the post has a bore defined therein. The standoff may be integrally formed with the base plate, or separately formed from the base plate and extend through an aperture defined in the base plate. The clamping plate includes a first end and a second end, and has a second aperture defined therein. The first and second ends may be formed as saw-tooth edges, for example. The clamping plate may be formed of a flexible material such as, but not limited to spring steel. Each fastener includes a shaft configured for being disposed in the mounting location and the second aperture. The shaft is configured to be coupled with the bore of the post, such as through a threaded connection, so that the first and second ends of the clamping plate engage the first and second side walls to secure the motorized latch retraction assembly to the housing. The clamping plate has an arcuate cross-section taken along a longitudinal axis thereof prior to the first and second ends of the clamping plate engaging the first and second side walls. After the first and second ends of the clamping plate engage the first and second side walls, the clamping plate may be flat so that it is disposed on a plane and have a length that is equal to the distance between the side wall of the housing adjacent to the bottom wall of the housing.

In yet another aspect, a method of mounting a motorized latch retraction assembly within a housing of a door latch system, wherein the housing includes a first side wall, a second side wall, and a bottom wall disposed between the first side wall and the second side wall, and wherein the motorized latch assembly includes a mounting location. The method comprises a mounting bracket as described above. The method further comprises the steps of: disposing the base plate in the housing so that the first surface is adjacent to the bottom wall of housing; placing the clamping plate adjacent to the second surface of the base plate so that the standoff is disposed in the second aperture, wherein the clamping plate has an arcuate cross-section along the longitudinal axis in this step; positioning the motorized latch retraction assembly in the housing adjacent to the second surface of the clamping plate; positioning a fastener in the mounting location of the motorized latch assembly; and securably engaging the fastener in the bore of the post to cause the motorized latch retraction assembly to move the clamping plate toward the bottom wall of housing so that the first and second ends of the clamping plate engage the first and second side walls to securably mount the motorized latch assembly in the housing. When the first and second ends of the clamping plate are engaged with the first and second side walls to securably mount the motorized latch assembly in the housing, the clamping plate may be flat and disposed in a plane. The first side wall and the second side wall of the housing may also each include a nodule extending inwardly therefrom, wherein the first and second ends of the clamping plate may be disposed between the respective nodule and the bottom wall when the first and second ends of the clamping plate are engaged with the first and second side walls to securably mount the motorized latch assembly in the housing.

Numerous applications, some of which are exemplarily described below, may be implemented using the present invention.

### BRIEF DESCRIPTION OF THE DRAWINGS

The present invention will now be described, by way of example, with reference to the accompanying drawings, in which:

FIG. 1 is a front plan view of a door and a door latch system in accordance with an aspect of the present invention;

FIG. 2 is a perspective view of an exemplary embodiment of the door latch system in accordance with the present invention;

FIG. 3 is a perspective view of the exemplary embodiment of the door latch system shown in FIG. 2 with the push bar removed and a portion of a housing shown in phantom;

FIG. 4 is a perspective view of a portion of an actuating assembly shown in FIG. 3;

FIG. 5 is a left side perspective view of an exemplary embodiment of motorized latch retraction (MLR) assembly configured for use within the door latch system in accordance with an aspect of the present invention;

FIG. 6 is a right side perspective view of the MLR assembly shown in FIG. 5;

FIG. 7 is a partial exploded perspective view of the exemplary embodiment of the MLR assembly shown in FIGS. 5 and 6;

FIG. 8 is a partially enlarged view of an exemplary embodiment of a gear assembly for use within the MLR assembly as shown in FIGS. 5 and 6;

FIG. 9A is a bottom perspective view of the MLR assembly shown in FIG. 5;

FIG. 9B is an enlarged view of a portion of the MLR assembly shown in FIG. 9A showing a stop extending from a gear box of the MLR assembly;

FIG. 10A is a top perspective view of the exemplary embodiment of the MLR assembly shown in FIG. 5 with a housing removed including a capacitor unit attached thereto;

FIG. 10B is an expanded top perspective view of the capacitor unit and associated sensor units for the exemplary embodiment of the MLR assembly shown in FIG. 10A;

FIG. 11 is a top perspective view of an embodiment of a mounting bracket used to selectively mount the MLR assembly shown in FIG. 5 in the housing;

FIG. 12 is a bottom perspective view of the mounting bracket shown in FIG. 11;

FIG. 13 is an exploded view of the mounting bracket shown in FIG. 11 along with a portion of a gear box of the MLR assembly shown in FIG. 5;

FIG. 14 is a cross-sectional view taken along line 14-14 in FIG. 18 showing the mounting bracket of FIG. 11 in a disengaged position;

FIG. 15 is a cross-sectional view taken along line 15-15 in FIG. 19 showing the mounting bracket of FIG. 11 in an engaged position;

FIG. 16 is a cross-sectional view taken along line 16-16 in FIG. 19 showing the mounting bracket of FIG. 11 in the engaged position;

FIG. 17A is a cross-sectional view taken along line 16-16 in FIG. 19 showing the mounting bracket of FIG. 11 in a further engaged position;

FIG. 17B is a cross-sectional view similar to FIG. 17A showing an alternative method of securing the MLR assembly to the housing;

FIG. 18 is a top view of the MLR assembly shown in FIG. 5 with certain portions removed to show the mounting bracket of FIG. 11 shown in the disengaged position;

FIG. 19 is a top view similar to FIG. 18 showing the mounting bracket of FIG. 11 in the engaged position;

FIG. 20 is a partial side view of the exemplary embodiment of the MLR assembly in a state that would place the latch in a latched position;

FIG. 21 is a partial top perspective view of the MLR assembly shown in FIG. 20;

FIG. 22 is a side perspective view of the exemplary embodiment of the MLR assembly shown in FIGS. 20 and 21 in a state when the actuation assembly is manually depressed to retract the latch;

FIG. 23 is a side perspective view of the exemplary embodiment of the MLR in a state when the MLR assembly is used to automatically retract the latch;

FIG. 24 is an exploded view showing another exemplary mounting system for securing the exemplary MLR assembly shown in FIG. 5 within the door latch system;

FIG. 25 is a cross-sectional view of the exemplary mounting system and MLR assembly within the latch housing, with the mounting system shown in a preinstalled condition; and

FIG. 26 is a cross-sectional view of the exemplary mounting system and MLR assembly within the latch housing, with the mounting system shown in an installed condition.

Corresponding reference characters indicate corresponding parts throughout the several views. The exemplifications set out herein illustrate currently preferred embodiments of the present invention, and such exemplifications are not to be construed as limiting the scope of the invention in any manner.

### DESCRIPTION OF THE PREFERRED EMBODIMENTS

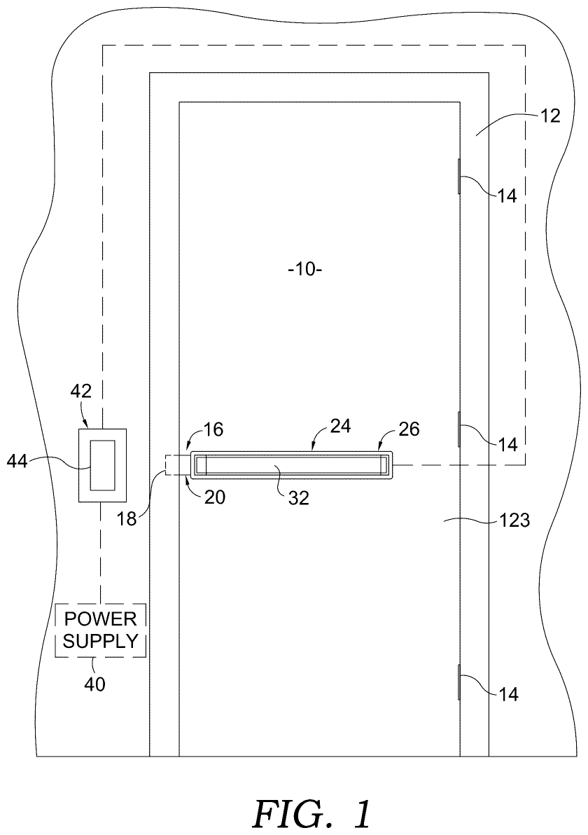

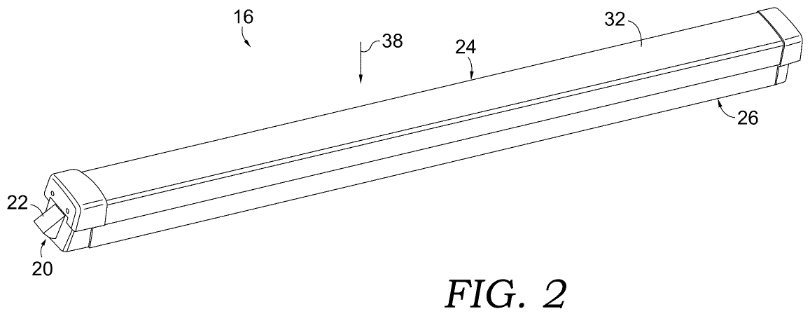

Referring initially to FIGS. 1 and 2, a typical door 10 is shown in a closed position within a door frame 12. Door 10 may be pivotally mounted to door frame 12 using hinges 14 so that door 10 is able to move between the closed position and an open position (not shown). Door 10 may be selectively secured in the closed position within door frame 12 using a door latch system 16. Door latch system 16 is coupled to door 10 and may operate in conjunction with a strike 18 mounted in or on door frame 12. Door latch system 16 may comprise a latch assembly 20 including a latch 22, and an actuating assembly 24 that operates to move latch 22 between extended and retracted positions. When latch 22 is the extended position and door 10 is in the closed position, latch 22 is disposed within strike 18 to secure door 10 to door frame 12. When latch 22 is moved to the retracted position by actuating assembly 24, latch 22 is removed from strike 18 which allows door 10 to move to the open position.

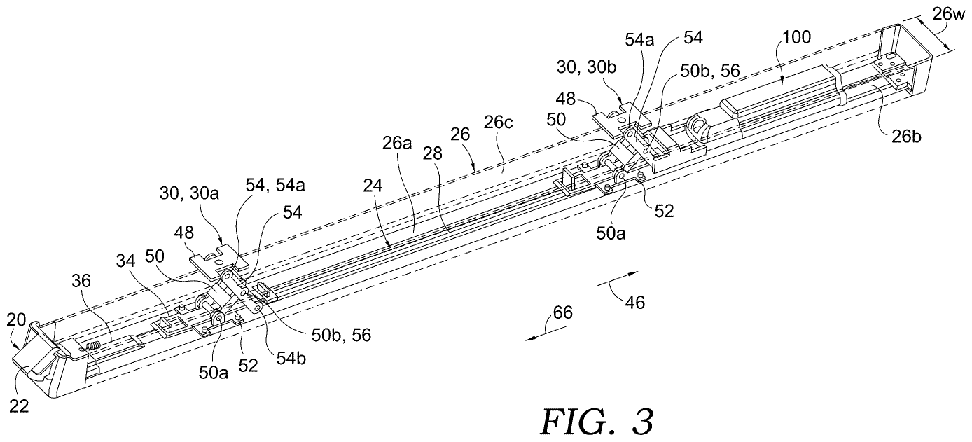

With additional reference to FIGS. 2 and 3, door latch system 16 may further include a housing 26 that is configured to be coupled to door 10 and is configured to allow latch assembly 20 and actuating assembly 24 to be mounted therein. Housing 26 may have a generally U-shaped cross-section including a bottom wall 26a having an internal width 26w defined by opposing generally perpendicular side walls 26b, 26c. Actuating assembly 24 may be, for example, in the form of a Pullman style latch assembly that operates as a linear-movement actuator to move latch 22 between extended and retracted positions. For example, actuating assembly 24 may include a driving member, such as an actuating bar 28, at least one actuating member 30 connected to opposite ends of actuating bar 28, and a push bar 32 that is mounted to actuating members 30. A proximal end 34 of the forwardmost actuating member 30a is coupled to latch mechanism 20. Latch mechanism 20 includes a drive linkage 36 which is in turn coupled with latch 22. As will be described in further detail below, actuating assembly 24 may be manually operated by depressing push bar 32 in a direction 38, which in turn causes latch assembly 20 to move latch 22 to the retracted position via drive linkage 36 so that door 10 can be moved to the open position. While latch assembly 20 is described herein as being a Pullman style latch assembly, it should be understood that the present invention may be used in association with other types of latch mechanisms, including but not limited to, a latch mechanism having a latch in the shape of a star wheel, a surface vertical rod latch mechanism, a concealed vertical rod latch mechanism, a mortise style latch mechanism, or other types of latch mechanisms.

As discussed above, push bar 32 is configured for manual depression, such as via physical pushing of push bar 32 in direction 38. In another aspect, door latch system 16 may additionally or alternatively be configured so that actuation assembly 24 and/or latch assembly 20 are automatically operated to retract latch 22 using a motor, a solenoid, or other type of actuator so that door 10 can be moved to the open position as will be described in greater detail below. In order to provide for automatic retraction of latch 22, as seen in FIG. 1, actuating assembly 24 may be in direct or indirect communication with a power supply 40 such as, for example, battery power or a 12 or 24 volt circuit, which in turn may be hardwired to the external electric power grid where power supply 40 is configured to receive 115 VAC or 230 VAC line voltage. Electrical power to actuating assembly 24 may be selectively controlled via an access control system (ACS) 42. ACS 42 may be locally positioned proximate door 10 as shown in FIG. 1 and/or may be remotely located relative to door 10 within a centralized security operations center, for example. ACS 42 may include a push-to-exit button or an authentication device 44, such, as but not limited, to a keypad, swipe card reader, key fob reader or biometric sensor in communication with ACS 42 whereby actuation assembly 24 and/or latch assembly 20 are actuated only upon an exit signal (or door unlatching signal) generated by selection of the push-to-exit button, or input of proper access credentials at authentication device 44, to thereby allow latch 22 to be automatically be retracted and removed from strike 18. It is also contemplated that the exit signal be generated automatically upon detection of an emergency event, such as a fire for example. In either case, automatic operation of actuation assembly 24 and/or latch assembly 20 may result in the depression of push bar 32 relative to housing 26 in direction 38 and the retraction of latch 22 in an unlocking direction 46 which is generally orthogonal to actuating direction 38 to disengage latch 22 from strike 18.

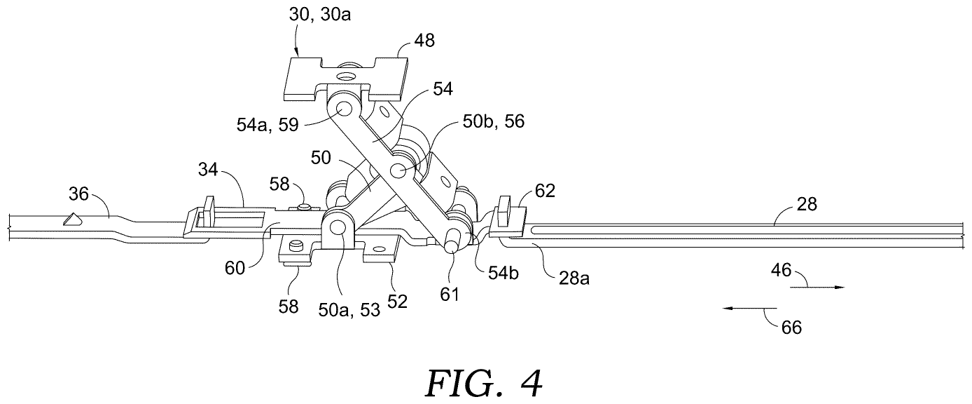

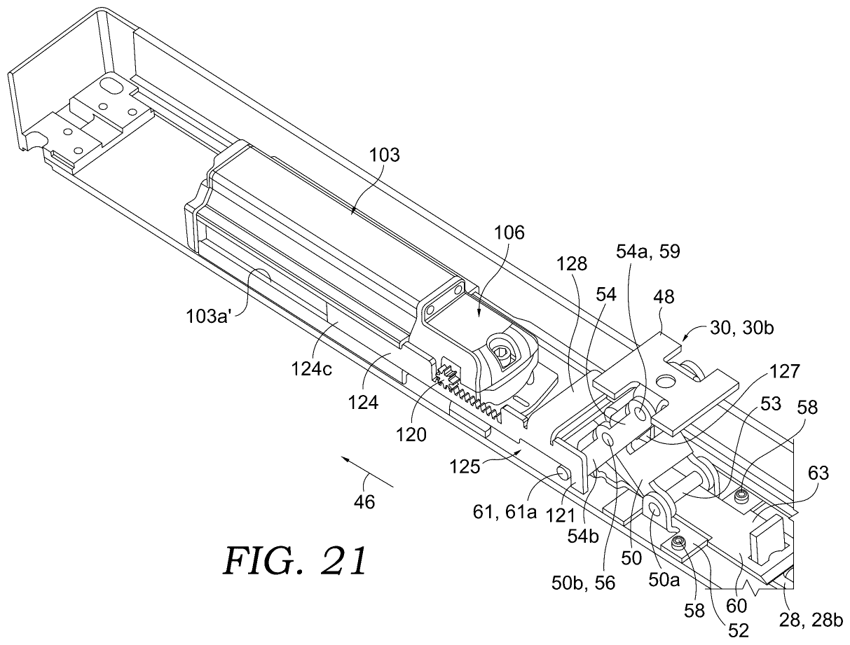

With reference to FIGS. 3, 4 and 21, push bar 32 may be coupled to at least one actuating member 30 (e.g., actuating members 30a, 30b) by way of respective bar mount 48 situated on each actuating member 30. Each actuating member 30 may include a fixed leg 50 secured to a mounting bracket 52 at a first end 50a via a shaft 53, and to a pivoting leg 54 at the opposing second end 50b via a pivot shaft 56. Mounting bracket 52 is fixedly mounted to housing 26 using one or more fasteners 58 (FIGS. 4 and 21). Pivoting leg 54 may be pivotally coupled to bar mount 48 at a first end 54a via a shaft 59. A second end 54b of pivoting leg 54 is fixedly connected to a slider bar 60 via a shaft 61. Slider bar 60 is movably mounted relative to mounting base 52. As seen in FIG. 4, slider bar 60 of actuator member 30a is connected to drive linkage 36 of latch assembly 20 at proximal end 34, and a distal end 62 of slider bar 60 is coupled with one end 28a of actuating bar 28 so that it moves linearly in conjunction with drive linkage 36 of latch assembly 20. As seen in FIG. 21, the other end 28b of actuating bar 28 is coupled with a proximal end 63 of slider bar 60 of actuating member 30b whereby slider bars 60 associated with actuating members 30a, 30b, actuating bar 28, and drive linkage 36 all move in unison with one another to dictate the position of latch 22.

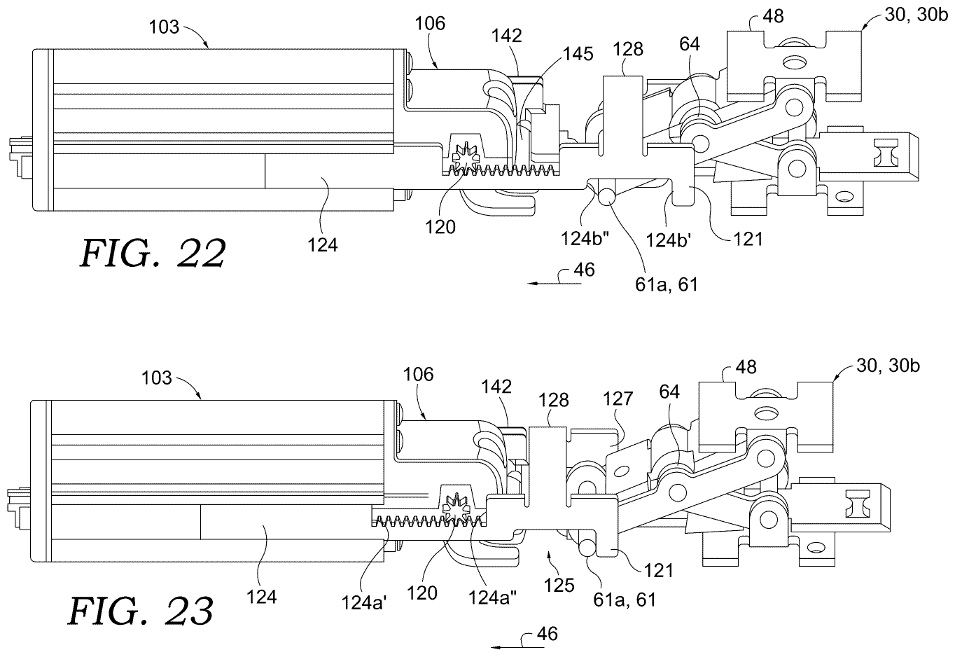

Housing 26 may be fixedly secured to door 10 such that movement of push bar 32 in the actuating direction 38 pivots pivoting leg 54 about pivot shaft 56 thereby causing actuating bar 28 to translate in the unlocking direction 46 and causing latch 22 to disengage from strike 18. Each actuating member 30 may further include a biasing member 64 (see FIG. 22) which may operate to urge actuating member 28 in a locking direction 66 to reverse pivot actuating member 30 and return push bar 32 to the extended position as shown in FIG. 2. Additionally or alternatively, latch assembly 20 may include a biasing member (not shown) having one end secured to latch assembly 20, such as on drive linkage 36, and a second end secured to housing 26 so as to urge latch 22 to the extended latched position and push bar 32 to the extended position. In either or both instances, latch 22 may then be placed in the extended position so as to engage strike 18 and secure door 10 in door frame 12. It should be noted that actuating assembly 24 (and associated push bar 32 and housing 26) may be fabricated in various standard or custom lengths so as to accommodate doors of varying widths.

With reference to FIG. 3, and in accordance with an aspect of the present invention, door latch system 16 may further include a motorized latch retraction (MLR) assembly 100 configured to be selectively coupled to actuating assembly 24 to automatically retract latch 22 upon receipt of the exit signal from ACS 42. In one exemplary aspect of the present invention, MLR assembly 100 may be coupled to the distal-most actuating member 30b (i.e., the actuating member 30 furthest from latch 22 within housing 26), as will be described in greater detail below.

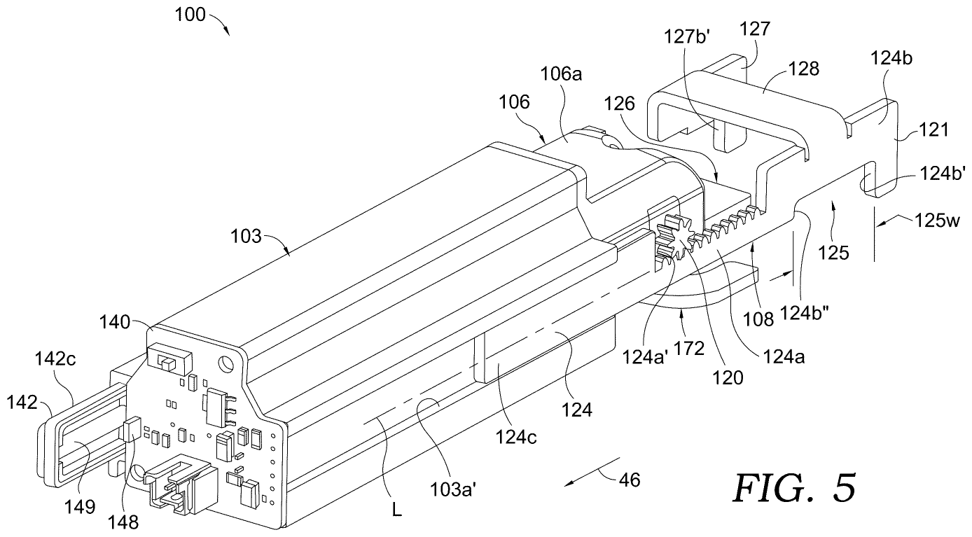

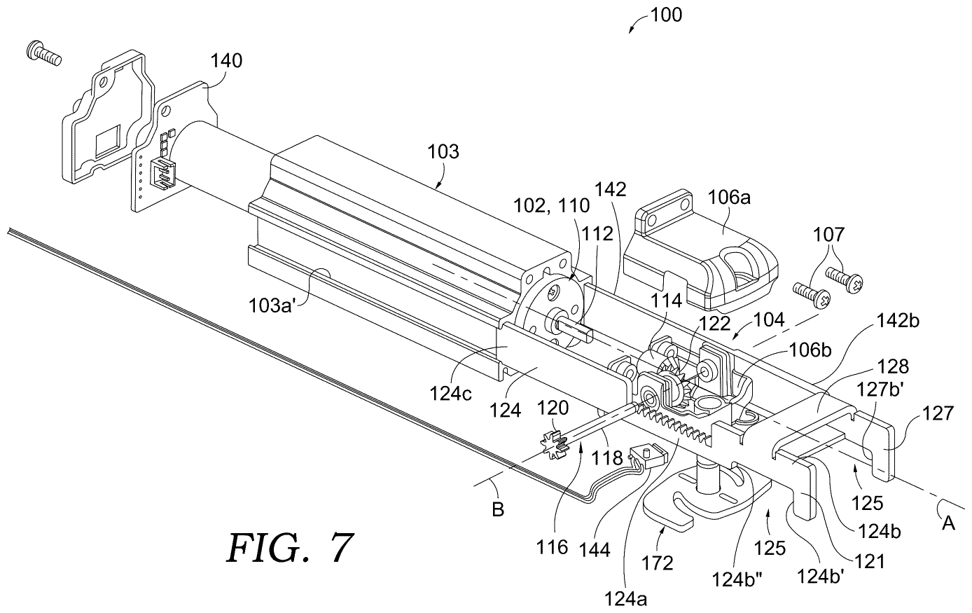

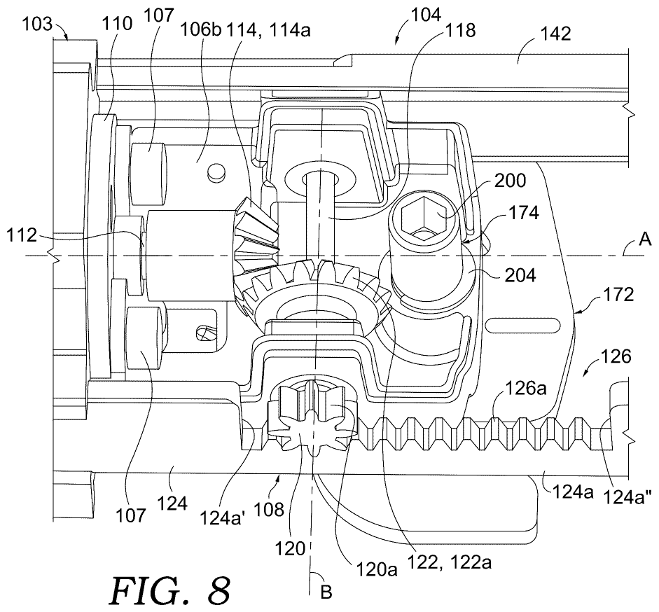

With reference to FIGS. 5-8, MLR assembly 100 may generally include an electromechanical actuator 102 disposed in an enclosure 103 and operationally coupled to a gear assembly 104. Gear assembly 104 is housed within a gear box 106 having gear box halves 106a, 106b. Gear box halves 106a, 106b may be mounted to enclosure 103 using fasteners 107. Gear assembly 104 is configured to selectively drive a rack and pinion drive mechanism 108 to move latch 22 to the retracted position. With reference to FIG. 8, exemplary electromechanical actuator 102 includes an electric motor 110 configured to rotate a drive shaft 112 about a first axis A when provided power from power supply 40. By way of example and without limitation, electric motor 110 may be a DC motor including a speed reduction gear box, wherein the gear box is either a spur gear box or, a planetary gear box having a gear reduction ratio sufficient to prevent back driving of the motor when power is disconnected to the motor, as will be described in greater detail below. Mounted on drive shaft 112 is a first bevel gear 114 whereby powering of motor 110 causes first bevel gear 114 to rotate about first axis A. It should be understood that the use of first bevel gear 114 is merely exemplary and other types of gears is contemplated and within the scope of the present invention including, but not limited to, a miter gear, helical gear, or crown gear, for example.

Rack and pinion drive mechanism 108 includes a pinion gear 116 having a pinion shaft 118 and a terminal rack gear 120. A second bevel gear 122 is mounted on pinion shaft 118 such that bevel gear teeth 122a of second bevel gear 122 engage with bevel gear teeth 114a of first bevel gear 114 whereby rotation of first bevel gear 114 about first axis A causes rotation of second bevel gear 122, and therefore pinion gear 116, about a second axis B. In one aspect, first axis A is perpendicular to second axis B. First axis A and second axis B may also be co-planar and/or generally parallel to the longitudinal plane defined by an inside surface 123 (FIG. 1) of door 10.

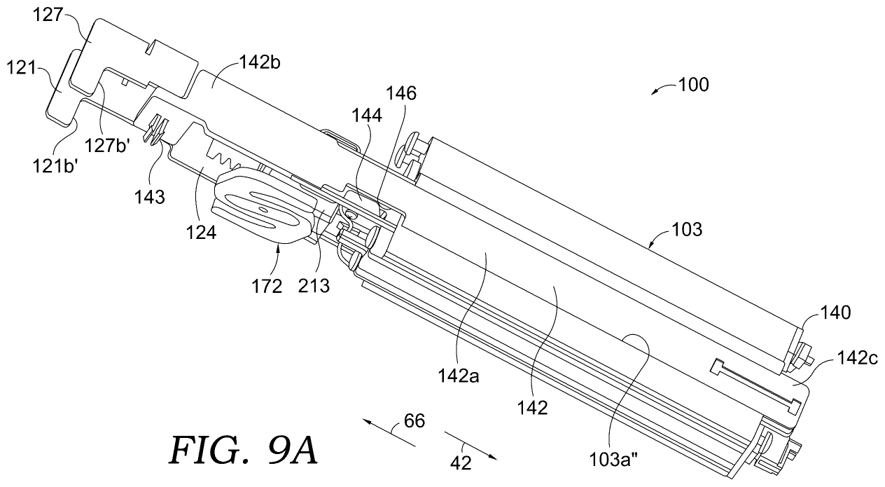

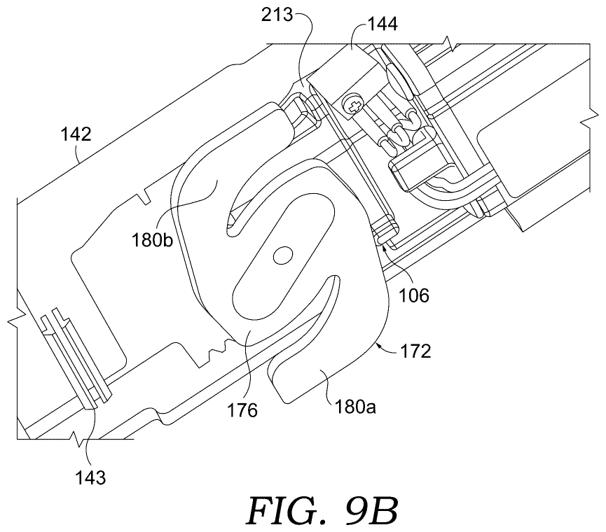

Rack and pinion drive mechanism 108 may further include a drive arm 124 which defines a rack member 126 along a center portion 124a of drive arm 124. Rack member 126 comprises a plurality of rack teeth 126a which are proportioned to engage with corresponding rack gear teeth 120a of rack gear 120 on pinion shaft 118. A forward portion 124b of drive arm 124 includes a first engagement arm 121. Forward portion 124b comprises a slotted section 125 that extends between a front wall 124b′ of first engagement arm 121 and a rear wall 124b″ defined by drive arm 124. Slotted section 125 may have a width 125w that extends along a longitudinal axis L of drive arm 124. Slotted section 125 is configured to receive a first end 61a of shaft 61 (FIG. 23) located on second end 54b of pivot leg 54 of actuating member 30b. Front wall 124b′ is configured to selectively engage first end 61a of shaft 61 to move latch 22 to the retracted position, as will be described in greater detail below. Rack and pinion drive mechanism 108 may further optionally include a second engagement arm 127 that is coupled with forward portion 124b of drive arm 124 using a connector member 128. Second engagement arm 127 includes a front wall 127b′ that is configured to selectively engage a second end 61b (FIGS. 9 and 19) of shaft 61 (along with first engagement arm 121) to move latch 22 to the retracted position. A back portion 124c of drive arm 124 is configured to be received within a first channel 103a′ defined within housing 103 of electromechanical actuator 102 to guide and enable lateral translation of drive arm 124 (along with second engagement arm 127) upon selected powering of motor 110 as will be described in greater detail below. By selectively engaging first engagement arm 121 with first end 61a of shaft 61 and engaging second engagement arm 127 with second end 61b of shaft 61, this allows drive arm 124 to provide a balanced pulling force on shaft 61 when laterally translating drive arm 124 in direction 46 and reduces unwanted torque and rotation of shaft 61 when latch 22 is being retracted by motor 110.

With continued reference to FIGS. 5-7 and 9A, MLR assembly 100 may further include a control board 140 communicatively coupled to, and configured to operably control, electromechanical actuator 102 to move latch 22 of latch assembly 20 in unlocking direction 46 so as to disengage latch 22 from strike 18, as described above with regard to FIGS. 1-4, and as will be described in greater detail below. A carrier link 142 may include a center portion 142a configured to be slidably coupled within a second channel 103a″ defined within electromechanical actuator enclosure 103. A forward end 142b of carrier link 142 may include a coupling mechanism 143 which is configured to securely couple carrier link 142 to distal end 145 (FIGS. 9A, 9B and 19) of slide bar 60 whereby movement of slide bar 60 in unlocking direction 46 (see FIG. 3) causes lateral translation of carrier link 142 as will be described in greater detail below. Coupling mechanism 143 may be, for example, and without limitation, a pair of snap arms that are configured to be placed within an aperture formed in distal end 145 of slide bar 60, however other fastening mechanisms may also be used.

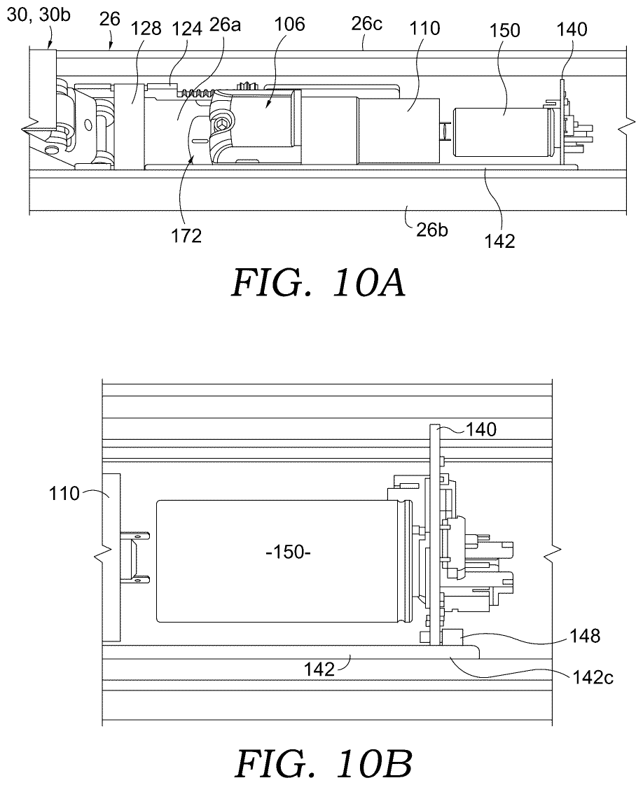

With additional reference to FIGS. 10A and 10B, electromechanical actuator 102 may further include control board 140 coupled thereto, whereby control board 140 may be communicatively and operably coupled to ACS 42 to selectively control powering of motor 110. In one aspect of the invention, control board 140 may be further be configured to monitor the condition of latch 22, i.e., whether push bar 32 is in the extended position (latch in the extended latched position as shown in FIGS. 1 and 2) or the depressed/dogged position (latch in the retracted position as indicated by actuating member 30b/bar mount 48 position as shown in FIGS. 22 and 23).

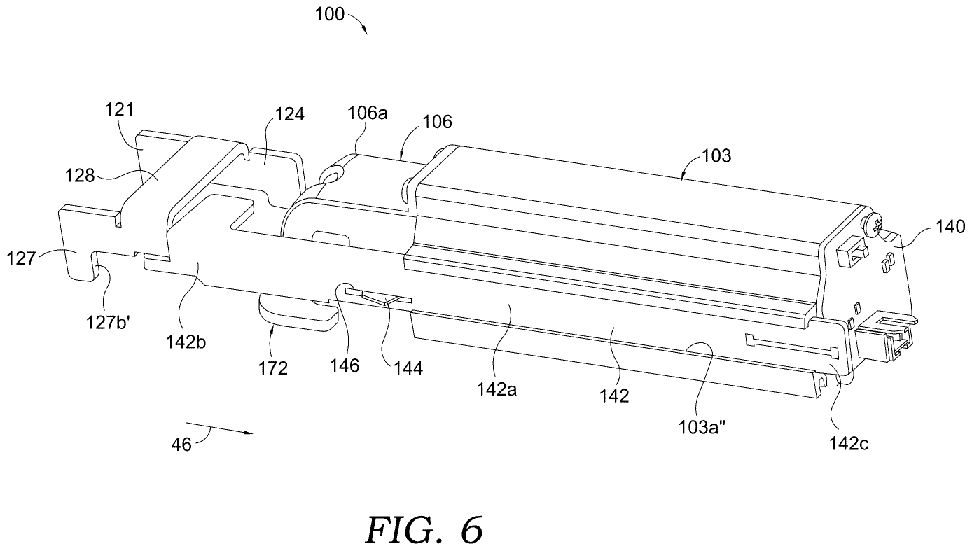

By way of example, with reference to FIGS. 5-7, 9A and 9B, control board 140 may include, or be otherwise communicatively, coupled to a microswitch 144. Microswitch 144 may be coupled with gear box 106 and positioned to interact with carrier link 142. As will described in greater detail below, when latch 22 is in the extended position, rear end carrier link 142 is positioned in a manner to allow microswitch 144 to be in a first position (FIGS. 6 and 9A)(e.g., open position) indicating to ACS 42 that latch 22 is in the extended position. Manual depression of push bar 32 operates actuation assembly 24 to move latch 22 to the retracted position, which in turn freely translates carrier link 142 in direction 46 within a second channel 103a″ defined in housing 103 whereby microswitch switch 144 is placed in a second position (e.g., closed position) which results in a status communication being sent to ACS 42 indicating that latch 22 is in the retracted position. For example, in one exemplary embodiment, microswitch 144 may be at least partially disposed in a cut-out 146 defined in carrier link 142 when microswitch 144 is in the first position, as seen in FIGS. 6 and 9A. When push bar 32 is manually depressed to retract latch 22, carrier link 142 moves in direction 46 and contacts microswitch 144 as micro-switch moves out of cut-out 146 and begins to slide against an inner surface of carrier link 142 to place microswitch 144 in the closed position. Thus, microswitch 144 is used to identify the position of latch 22 during manual depression of push bar 32 regardless of whether MLR assembly 100 is operational or not.

In a further aspect, with reference to FIGS. 5, 6, 9A and 10B, control board 140 may also include, or be otherwise communicatively coupled to, a Hall effect sensor 148 whereby a rear end 142c of carrier link 142 is positioned adjacent to Hall effect sensor 148 to signal ACS 42 that latch 22 is in the extended position. For example, as will be discussed further below, when motor 110 is powered on to retract latch 22, Hall effect sensor 148 is also powered. As MLR assembly 100 operates to move latch 22 to the retracted position, carrier link 142 translates laterally in direction 46 so that Hall effect sensor 148 detects that a magnet 149 associated with rear end 142c is no longer adjacent Hall effect sensor 148. With latch 22 in the retracted position, Hall effect sensor 148 may then trigger ACS 42 to output a control signal to cut off power to motor 110.

As further shown in FIGS. 10A and 10B, MLR assembly 100 may further include a capacitor 150 electrically coupled to motor 110 whereby powering of motor 110 to move latch 22 from the extended position to the retracted position further operates to charge capacitor 150. When latch 22 is driven to the retracted position using MLR assembly 100 via powering of motor 110 and Hall effect sensor 148 triggers ACS 42 to cut off power to motor 110, ACS 42 also operates to cut power to capacitor 150. At this point, capacitor 150 stores the electric charge for later use, as will be described in greater detail below.

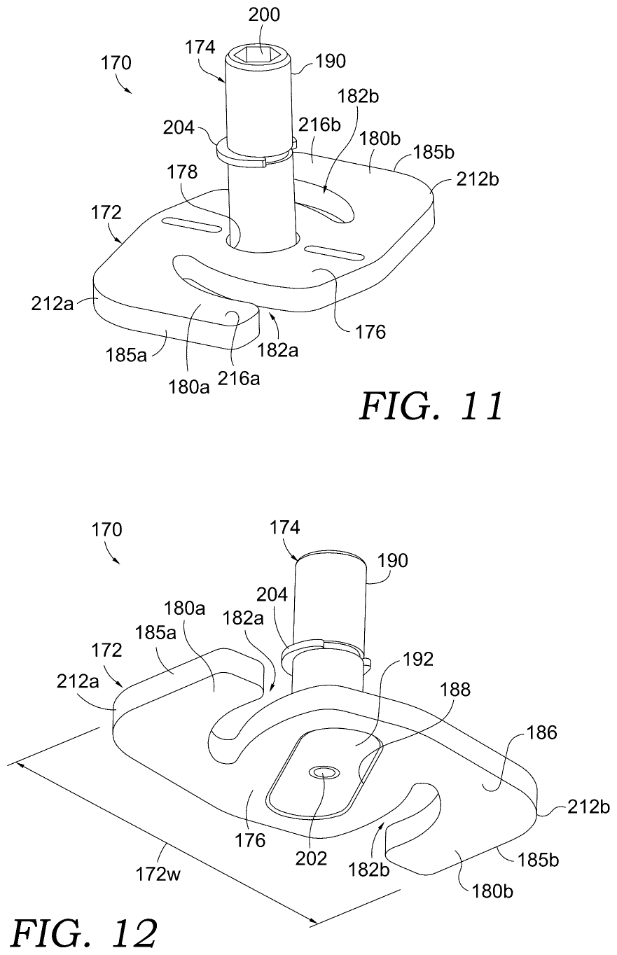

In aspect of the present invention, MLR assembly 100 may be configured as a kit for fitting within a new or existing door latching system that does not provided for automatic retraction of latch 22, or for use in place of an existing motorized latch retraction assembly previously installed within a latch system. With particular reference to FIGS. 11-13, MLR assembly 100 may include a mounting bracket 170 selectively positionable to operably mount MLR assembly 100 within housing 26 without predrilling or otherwise modifying housing 26. By way of example and without limitation, and with continued reference to FIGS. 11-13, mounting bracket 170 may be comprised of a clamping plate 172 and a positioning component 174. In general, positioning component 174 is rotatably mounted to MLR assembly 100, such as, for example, gear box 106 which contains gear assembly 104. Positioning component 174 is engaged with clamping plate 172 and operates to selectively move clamping plate 172 between a disengaged position and an engaged position by rotation of positioning component 174 relative to gear box 106. As will be discussed further below, when clamping plate 172 is in the engaged position, mounting bracket 170 is engaged with housing 26 to secure the MLR assembly 100 to housing 26.

In one exemplary embodiment, clamping plate 172 may include a base section 176 having an aperture 178 defined therein configured to receive a portion of positioning component 174. Further, clamping plate 172 may include at least one flange, such as, for example, first and second flanges 180a, 180b, that extend from opposite sides of base section 176. For example, first and second flanges 180a, 180b may be configured such that a respective gap 182a, 182b is defined between first and second flanges 180a, 180b and base section 176. Each gap 182a, 182b has a respective first width 184a, 184b when clamping plate 172 is in the disengaged position. It should be understood that first width 184a, 184b may be equal or different than each other. In addition, each of first and second flanges 180a, 180b include an outer surface 185a, 185b that defines a width 172w (FIG. 12) of clamping plate 172. When mounting bracket 170 is in the disengaged position, clamping plate 172 in in a first state such that width 172w is slightly greater than a width 26w (FIGS. 15, 18 and 19) of housing 26. It should also be understood that in the instance that only one flange is included clamping plate 172, width 172w would be defined between the outer surface of the flange and the base section 176. A bottom surface 186 of clamping plate 172 may have a recess 188 defined therein.

Positioning component 174 may include a shaft 190 having a flanged end portion 192. Shaft 190 is configured to be disposed in recess 188 of clamping plate 172, and flanged end portion 192 may be configured to nest within recess 188 of clamping plate 172 (FIG. 12) so that positioning component 174 and clamping plate 172 rotate in unison. It should be understood that shaft 190 may be connected to clamping plate 172 by, for example, configuring recess 188 in a non-circular shape, connecting flanged end portion 192 with clamping plate 172 using a fastener or adhesive, and/or by integrally forming shaft 190 with clamping plate 172 and eliminating flanged end portion 192.

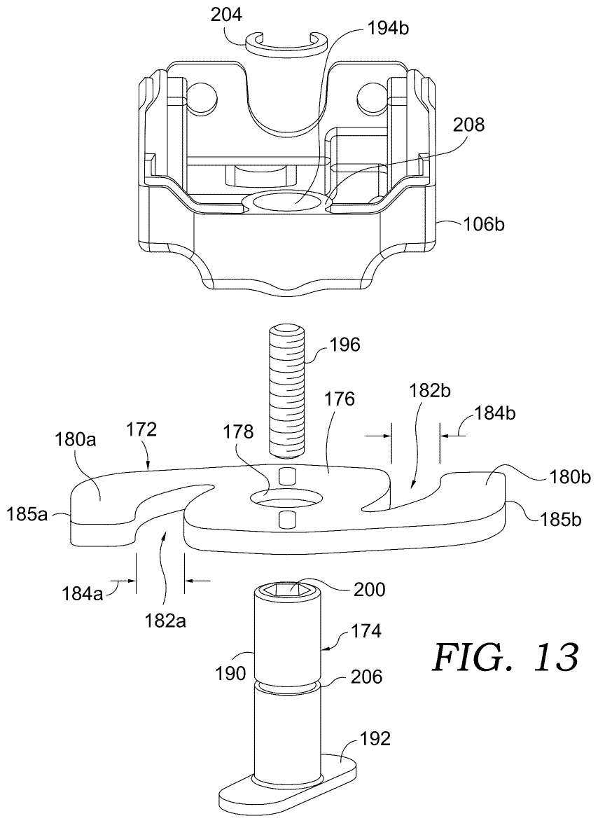

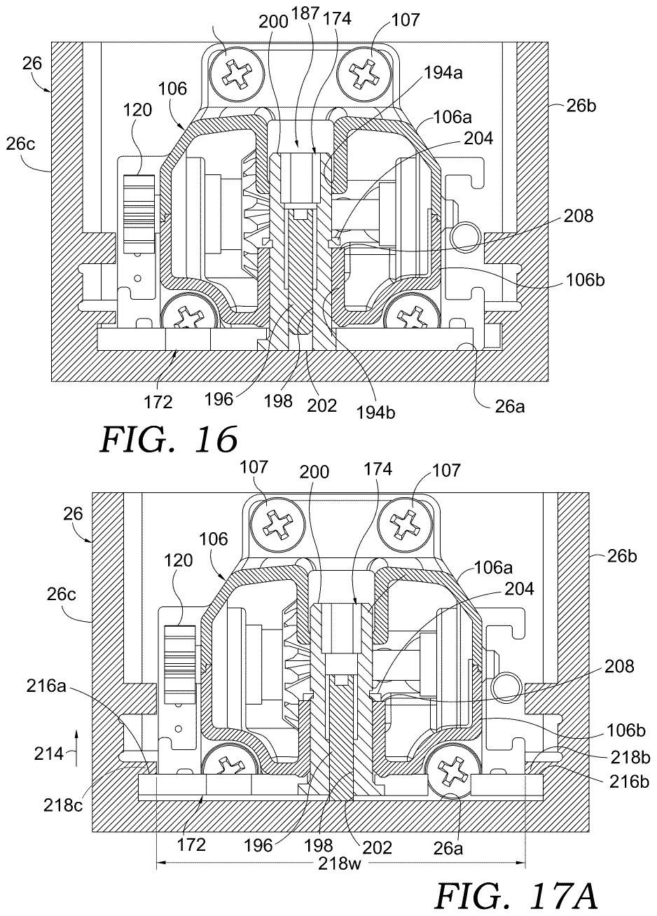

Shaft 190 is further configured to be rotatably mounted in a mounting location 187 on MLR assembly 100, such as, for example, within an aperture 194a, 194b defined in gear box 106. Positioning component 174 may further include a threaded set screw 196 that is configured to be threadably engaged within a threaded bore 198 defined in shaft 190. Threaded bore 198 of shaft 190 includes first and second open ends 200, 202. First open end 200 of shaft 190 is configured to allow set screw 196 to be inserted therein, and second open end 202 is configured to allow a portion of set screw 196 to extend outwardly therefrom, as will be discussed in greater detail below. With reference to FIGS. 13 and 16, for example, positioning component 174 may be rotatably mounted to gear box 106 by disposing clamping plate 172 on one side of gear box 106, and a fastener 204, such as a C-clip, disposed in a channel 206 formed in shaft 190 and engaged with an opposing surface 208 of gear box 106.

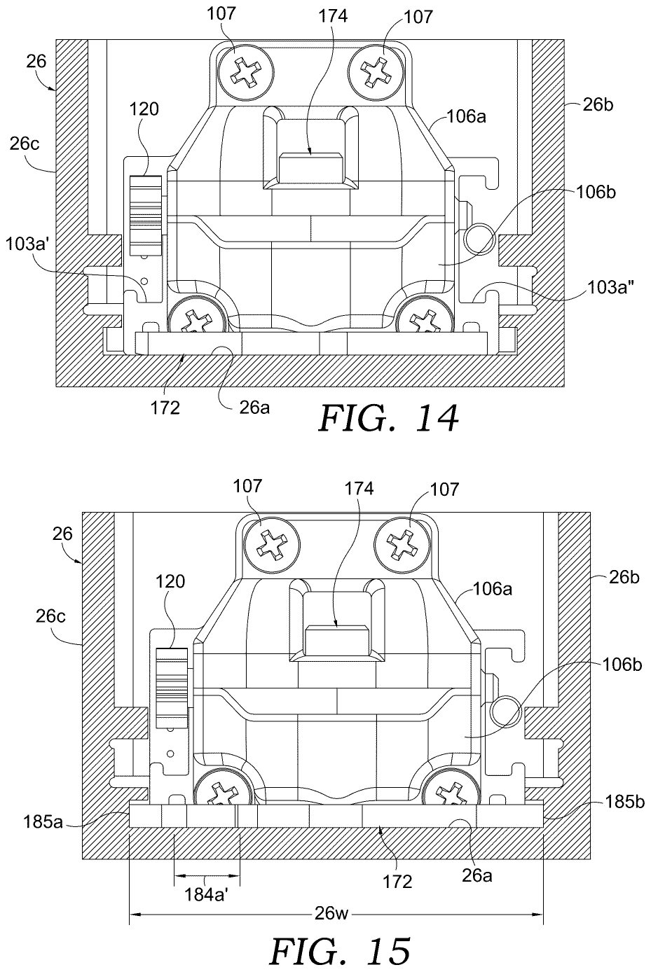

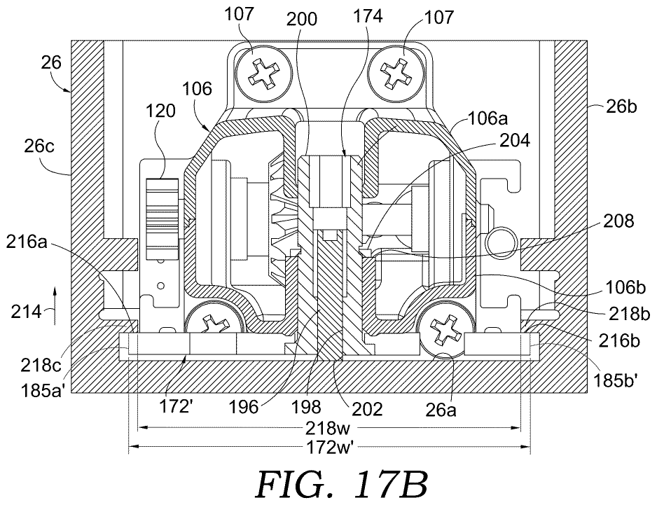

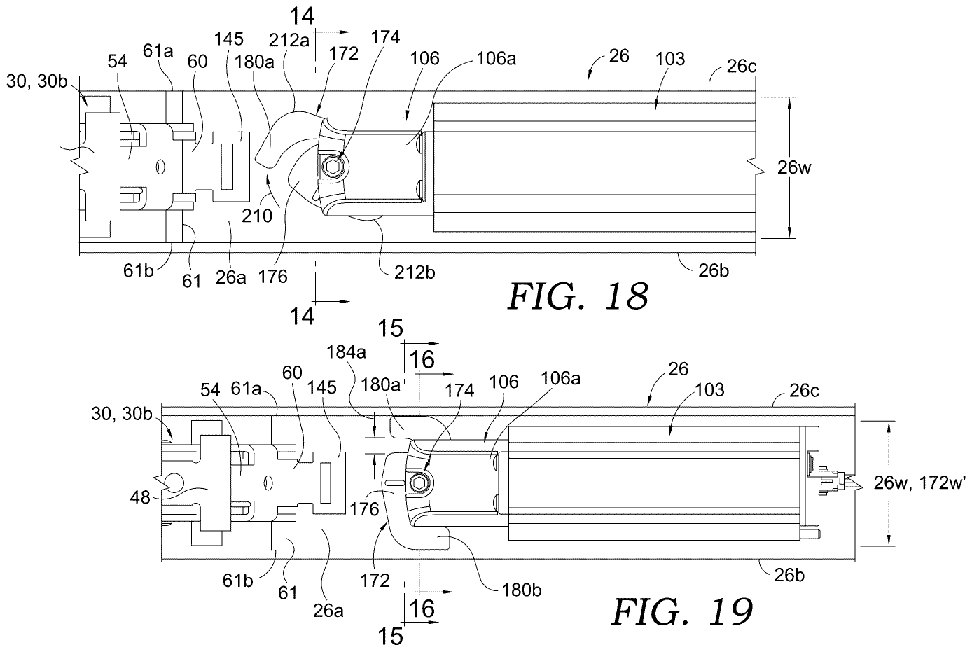

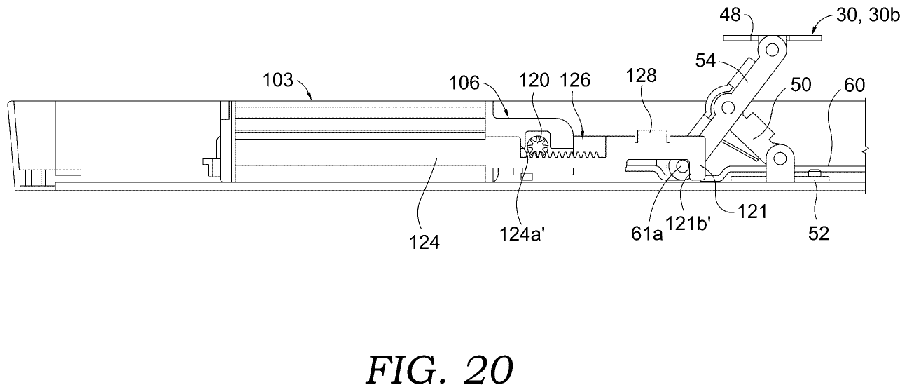

The mounting of MLR assembly 100 within housing 26 will now be described below. With reference to FIGS. 9A, 18, 20 and 21, MLR assembly 100 is inserted into housing 26 so that respective front walls 124b′, 127b′ of first and second engagement arms 121, 127 are adjacent and/or in contact with first and second ends 61a, 61b of shaft 61 and drive arm 124 is in an extended position as seen in FIG. 20. Further, coupling mechanism 143 (FIG. 9A) located on forward end 142b of carrier link 142 is connected to distal end 145 of carrier link 142 to couple carrier link 142 to slide bar 60 of actuator member 30b. With MLR assembly 100 being operationally coupled with actuating member 30b, MLR assembly 100 may be secured within housing 26 using mounting bracket 170. When MLR assembly 100 is initially placed with housing 26, mounting bracket 170 is in the disengaged position as best seen in FIGS. 14 and 18. First open end 200 of shaft 190 is then rotated in a direction 210 to place clamping plate 172 in the engaged position shown in FIGS. 15, 16 and 19. As clamping plate 172 is rotated to this position, a cammed surface 212a, 212b on each of the flanges 180a, 180b are placed in sliding contact with respective side walls 26b, 26b of housing 26. The continued rotational motion of clamping plate 172 causes flange 180a to bend inwardly toward base section 176 to reduce the first width 184a of the respective gap 182a to a second width 184a', and causes flange 180b to bend inwardly toward base section 176 to reduce the first width 184b of the respective gap 182b to a second width (not shown). In order to avoid over torquing clamping plate 172 in the engaged position, gear box 106 may have a stop 213 extending therefrom that is positioned to engage flange 180b when clamping plate 172 reaches or extends just beyond the engaged position, as seen in FIGS. 9A and 9B. Further, clamping plate 172 is placed in a second state when in the engaged position such that width 172w′ (FIG. 19) is equal to width 26w of housing 26. Thus, each flange 180a, 180b operates to impose an outward bias force towards the respective side wall 26b, 26c to secure clamping plate 172 to housing 26. To further secure clamping plate 172 to housing 26, set screw 196 may be rotated within shaft 190 from the position shown in FIG. 16 to the position shown in FIG. 17A so that at least a portion of set screw 196 extends outwardly from second open end 202 of threaded bore 198 and into engagement with bottom wall 26a of housing 26. As set screw 196 extends outwardly from second open end 202, clamping plate 172, as well as the MLR assembly 100, moves in a direction 214 so that a top surface 216a, 216b of each flange 180a, 180b engages a lower surface of at least one nodule extending into a cavity of the housing, such as, for example, a respective inwardly facing nodule 218b, 218c. In order to allow clamping plate 172 to engage nodules 218b, 218c, the distance 218w (FIG. 17A) between nodules 218b, 218c is less than the width 172w (FIG. 12) of clamping plate 172. Thus, clamping plate 172 operates to secure MLR assembly 100 to housing 26 through the engagement of flanges 180a, 180b with side walls 26b, 26c of housing and nodules 218b, 218c. It should be understood that MLR assembly 100 can also be disengaged with housing 26 by reversing the process described above by disengaging set screw 196 with bottom wall 26a of housing, and rotating clamping plate 172 back to the disengaged position shown in FIG. 18.

In another exemplary embodiment, and with reference to FIG. 17B, clamping plate 172′ may be used to secure the MLR assembly 100 to housing 26 only through engagement with nodules 218b, 218c without direct engagement of outer surfaces 185a', 185b′ of one or more of respective flanges 180a, 180b with side walls 26b, 26c of housing 26 as previously described. Thus, width 172w′ of clamping plate 172′ may be less than the width 26w of housing 26 such that when clamping plate 172′ is rotated to a position similar to that shown in FIG. 19, outer surfaces 185a', 185b′ of one or more of respective flanges 180a, 180b are not in contact or otherwise engaged with side walls 26b, 26c of housing 26. As such, clamping plate 172′ need not have gaps 182a, 182b defined therein to form a separate base section 176 and flanges 180a, 180a, and thus clamping plate 172′ may be a continuous plate, for example. In this aspect, the distance 218w between nodules 218b, 218c is less than the width 172w′ of clamping plate 172′ so that top surface 216a, 216b of clamping plate 172′ engages a lower surface of each inwardly facing nodule 218b, 218c when at least a portion of set screw 196 extends outwardly from second open end 202 of threaded bore 198 and into engagement with bottom wall 26a of housing 26.

Turning now to the operation of exemplary MLR assembly 100, FIGS. 20 and 21 show MLR assembly 100 installed within housing 26 with push bar 32 (FIG. 2) and actuating member 30b (and the other actuating member(s) 30, 30a) in the extended non-depressed position so that latch 22 is in the extended position. As can be seen, drive arm 124 and carrier link 142 are in a fully forward position with a first end 61a of shaft 61 positioned adjacent to engagement arm 121, and the opposing second end 61b of shaft 61 positioned adjacent to engagement arm 127. Rack gear 120 may also be located at or adjacent to rear wall 124a′ of drive arm 124.

With reference to FIG. 22, exemplary MLR assembly 100 is unpowered while push bar 32 (FIG. 2) has been manually depressed in direction 38 such that actuating member 30b (and other actuating member(s) 30, 30a) is in the depressed position so that latch 22 is retracted from strike 18 such that door 10 is able to be moved to the open position. At least one actuating member 30a, 30b may further include biasing member 64 (such as but not limited to a coil spring) which may operate to urge the respective actuating member 30a, 30b to reverse pivot and return push bar 32 back to the extended position whereby latch 22 is returned to the extended position so as to engage strike 18 and secure door 10 in door frame 12 as shown in FIGS. 1 and 2.

With drive arm 124 in the fully forward position shown in FIG. 22 and push bar 32 manually depressed to place latch 22 in the retracted position, both ends 61a, 61b of shaft 61 of actuating member 30b decouple from engagement arms 121, 127 and moves laterally within respective slotted sections 125 until end 61a is proximate to or engages with rear wall 124b″ of drive arm 124. In view of the connection between coupling mechanism 143 (FIG. 9A) of carrier link 142 and distal end 145 of slide bar 60, movement of shaft 61 in unlocking direction 46 causes carrier link 142 to engage micro-switch 144. The engagement of micro-switch 144 results in control board 140 sending a signal to ACS 42 indicative of latch 22 being in the retracted position. Once manual pressure is removed from push bar 32, or after a preselected length of time, biasing member 64 urges actuating member 30b to reverse pivot and return push bar 32 to the extended position whereby latch 22 is placed in the extended position.

As shown in FIGS. 8 and 23, in one exemplary embodiment, powering of motor 110 may cause counterclockwise rotation of drive shaft 112 and first bevel gear 114 about first axis A. This counterclockwise rotation about first axis A may then drive clockwise rotation of second bevel gear 122 (and thus pinion shaft 118 and rack gear 120) about second axis B. Clockwise rotation of rack gear 120 may then advance drive arm 124 in a rearward direction 46 so that rack gear 120 is positioned closer to, proximate to or engages a forward wall 124a″ of drive arm 124 (i.e., a rearward position as shown in FIG. 23). As drive arm 124 is moved to the fully rearward position, distal-most actuating member 30b (and other actuating member(s) 30, 30a) are pivoted to the downward unlatched position and push bar 32 is pulled into the depressed position. Latch 22 is moved to retracted position so that it is withdrawn from strike 18 and door 10 is able to be moved to the open position.

As discussed above, powering of motor 110 to retract latch 22 also powers Hall effect sensor 148 such that, as latch 22 moves to the retracted position, carrier link 142 translates so that Hall effect sensor 148 detects that rear end 142c and magnet 149 are no longer adjacent Hall effect sensor 148. With latch 22 in the retracted position, Hall effect sensor 148 may then trigger ACS 42 to output a control signal to cut off power to motor 110. Additionally, powering of motor 110 further operates to charge capacitor 150 whereby capacitor 150 may then store the electric charge for later use.

As discussed above, electric motor 110 may be a DC motor including a speed reduction gear box, such as but not limited to a planetary gear box, having a gear reduction ratio sufficient to prevent back driving of the motor absent power to the motor. That is, in one aspect of the invention, the gear reduction ratio is selected such that the gear box within motor 110 can withstand the urging of biasing member 64 to reverse pivot actuating member 30b with a relatively low amount of power being provided to electric motor 110. Thus, if a low amount of power is supplied to motor 110, actuating member 30b will remain pivoted to the downward depressed position such that door 10 remains unlocked and freely openable. This is in contrast to existing systems that require a significant amount of power be provided to the motor in order to prevent back driving and movement of the actuating members back to the extended position to thereby place the latch in a locked position within the strike. Therefore, existing systems expend a considerable amount of power to hold the actuating assembly in a position where the latch is retracted, particularly in the case where it is desired that the latch be maintained in a dogged state. The present invention allows actuating assembly 24 to be held in the dogged position to maintain latch 22 in the retracted position by providing a low amount of power to the door latch system 16.

In another aspect, upon receipt of a control signal from ACS 42, expiration of a preselected time, or should there be an electrical power interruption to MLR assembly 100, capacitor 150 is configured to discharge the electric charge stored therein to initiate reverse (back) drive of motor 110. Motor 110 will reverse rotate drive shaft 112 whereby drive arm 124, carrier link 142 will be translated to their fully forward positions (see FIGS. 20 and 21). With the assistance of biasing member 64, back driving of motor 110 causes actuating member 30b to reverse pivot to its upward latched position such that push bar 32 returns to the extended position and latch 22 may then engage strike 18 to secure door 10 in door frame 12.

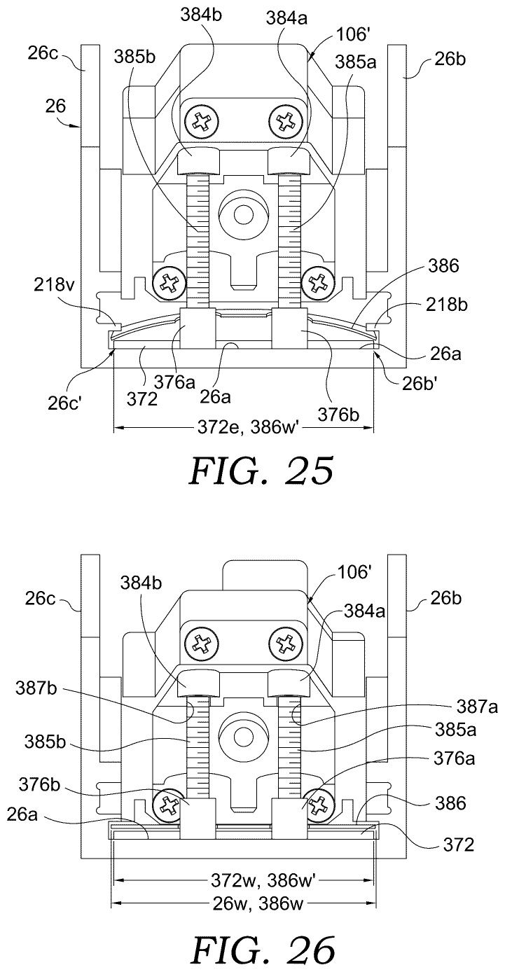

As previously mentioned, mounting bracket 170 was described as being used to secure MLR assembly 100 within housing 26. It should be understood that MLR assembly 100 can be mounted within housing 26 using other methods and still fall within the scope of the invention, such as, but not limited to, mounting bracket 370. Mounting bracket 370 may be comprised of a base plate 372 dimensioned to have a width 372w equal to or slightly smaller than width 26w (see, for example, FIG. 26) of bottom wall 26a. Base plate 372 may then to be received within housing 26 to rest along bottom wall 26a wherein distal ends 372a, 372b terminate proximate to their respective housing sidewall 26b, 26c. As shown in FIG. 25, each housing sidewall 26b, 26c may also include a respective inward facing nodule 218b, 218c which operates with housing bottom wall 26a to define respective channels 26b′, 26c′.

Base plate 372 further defines at least one aperture 374a, 374b therein, wherein each aperture 374a, 374b is configured to receive a corresponding number of standoffs 376a, 376b therethrough. Each standoff 376a, 376b may include a flanged head 378a, 378b adapted to engage a bottom surface 372c of base plate 372 so as to resist or prevent rotation of standoffs 376a, 376b within their respective apertures 374a, 374b. Each standoff 376a, 376b further includes a respective post 380a, 380b which define respective female threaded bores 382a, 382b. Each bore 382a, 382b is configured to threadably receive a respective shaft 385a, 385b from an associated mounting fastener or bolt 384a, 384b. It should be understood that the standoff(s) may be separately or integrally formed with base plate 372. Further, it is also contemplated that fasteners 384a, 384b and bores 382a, 382b be coupled to one other by non-threaded methods known to those skilled in the art.

Mounting bracket 370 may further comprise a clamping plate 386 positioned adjacent to a top surface 372d of base plate 372. Clamping plate 386 includes first and second surfaces 383a, 383b. Clamping plate 386 also includes opposing clamping ends 388a, 388b and further defines a pair of apertures 390a, 390b. In one aspect, each aperture 390a, 390b may be generally oval shaped and positioned along clamping plate 386 so as to coincide with standoffs 376a, 376b during installation of mounting bracket 370. Clamping plate 386 may be comprised of a flexible material, such as spring steel, and may be dimensioned to have a total clamping width 386w (see FIG. 26) which is slightly greater than width 372w of base plate 372 and width 26w of bottom wall 26a. Clamping plate 386 may further have a resting state wherein clamping plate 386 defines an arcuate or arced cross-section taken along its longitudinal axis such that a preinstalled width 386w′ of clamping plate 386 is substantially equal to width 26w (see FIG. 3) of bottom wall 26a.

As shown in FIG. 25, mounting bracket 370 may be selectively located along the longitudinal length of housing 26 with standoffs 376a, 376b coupled to base plate 372 and extending inwardly of housing 26 and clamping plate 386 arranged on top of base plate 372. Base plate end 372a and clamping end 388a may be received within bottom wall channel 26b′ while base plate end 372b and clamping end 388b are received within bottom wall channel 26c′. Clamping plate 86 is thus placed in a dome-like position within housing 26. Gear box 106′ may include one or more corresponding mounting locations, such as mounting holes 387a, 387b, that are configured to receive mounting fasteners 384a, 384b therein for threaded engagement with threaded bores 382a, 382b of the respective standoff 376a, 376b to securely mount MLR assembly 100 to housing 26.

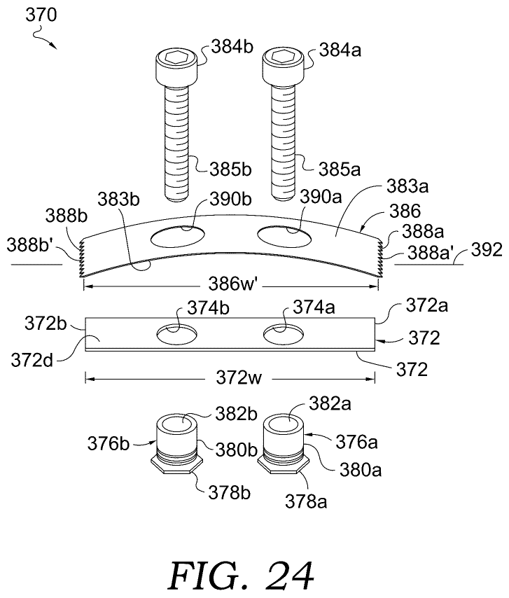

With reference to FIGS. 24 and 26, mounting fasteners 384a, 384b having been threadably advanced within their respective threaded bores 382a, 382b. As a result, gear box 106′ (and thus MLR assembly 100) engages the domed surface of clamping plate 386. Further advancement of mounting fasteners 384a, 384b and gear box 106′ may cause clamping plate 386 to flex clamping ends 388a, 388b outwardly to engage with, and more preferably physical grip the inner surface of housing sidewall 26b, 26c (e.g., clamping plate 386 expanded from initial preinstalled width 386w′ to clamping width 386w). In one aspect, to encourage and enhance clamping end 388a, 388b engagement of sidewalls 26b, 26c, each clamping end 388a, 388b may configured to include a respective serrated or saw-toothed edge 388a', 388b′ which may puncture or otherwise impact/engage housing sidewall 26b, 26c to secure mounting bracket 370 and MLR assembly 100 within housing 26.

From the foregoing, it will be seen that this invention is one well adapted to attain all the ends and objects hereinabove set forth together with other advantages which are obvious and which are inherent to the method and apparatus. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. As used herein, the terms “having” and/or “including” and other terms of inclusion are terms indicative of inclusion rather than requirement.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A motorized latch retraction assembly for installation within a door latch system, the door latch system including an actuating assembly for selectively moving a latch between an extended position and a retracted position for releasably securing a door in a door frame, the motorized latch retraction assembly comprising:
an electromechanical actuator configured for selectively receiving power from a power supply;
a gear assembly including a first gear and a second gear, wherein the first gear is operably coupled to the electromechanical actuator, and wherein the first gear is operably connected to the second gear; and
a rack and pinion drive mechanism including:
a drive arm defines a rack member, wherein the drive arm configured to be operably coupled to the actuating assembly, and
a pinion gear including a pinion shaft operably coupled to the second gear, wherein the pinion gear further includes a rack gear operably coupled to the rack member,
wherein when power is provided to the electromechanical actuator by the power supply, the electromechanical actuator operates the gear assembly and the pinion gear to move the drive arm in a linear direction such that the actuation assembly moves the latch between the extended position and the retracted position.

2. The motorized latch retraction assembly in accordance with claim 1 wherein the electromechanical actuator is a motor having a motor shaft rotatable about a first axis of rotation).

3. The motorized latch retraction assembly in accordance with claim 2 wherein the pinion shaft is rotatable about a second axis of rotation, wherein the first axis of rotation is perpendicular to the second axis of rotation.

4. The motorized latch retraction assembly in accordance with claim 3, wherein the first gear is a bevel gear, and wherein the second gear is a bevel gear.

5. The motorized latch retraction assembly in accordance with claim 1 wherein the drive arm is configured to decouple from the actuating assembly during manual actuation of the actuating assembly to move the latch from the extended position to the retracted position.

6. The motorized latch retraction assembly in accordance with claim 5 wherein a slotted section is defined in the drive arm, wherein the slotted section includes a front wall and a rear wall, and wherein the front wall is configured to be operably coupled to the actuating assembly when power is provided to the electromechanical actuator by the power supply.

7. The motorized latch retraction assembly in accordance with claim 1 wherein the drive arm includes a first engagement arm and a second engagement arm, wherein the actuating assembly includes a shaft having a first end and a second end, wherein the first engagement arm is configured to be engaged with the first end of the shaft and the second engagement arm is configured to engage the second end of the shaft when the drive arm moves in the linear direction to move the latch between the extended position and the retracted position.

8. The motorized latch retraction assembly in accordance with claim 7 wherein the first engagement arm and the second engagement arm are connected by a connector member.

9. The motorized latch retraction assembly in accordance with claim 8 wherein the power supply is at least one of a battery and a capacitor.

10. The motorized latch retraction assembly in accordance with claim 9 wherein the at least one of the battery and the capacitor power the electromechanical actuator when the power supply is cut off from the electromechanical actuator.

11. The motorized latch retraction assembly in accordance with claim 1 further comprising a mounting plate configured to secure the motorized latch retraction assembly within a housing of the door latch system without requiring holes within the housing.

12. The motorized latch retraction assembly in accordance with claim 1 further comprising:
a carrier link fixedly coupled to the actuating assembly and movably mounted to the electromechanical actuator;
a micro switch switch associated with the carrier link, wherein the micro switch switch is configured for determining when the actuating assembly is in a position indicative of the latch being in at least one of the retracted position or the extended position; and
a Hall Effect sensor associated with the carrier link, wherein when power is supplied to the electromechanical actuator the Hall Effect sensor determines when the latch has been moved to the retracted position so that the power from the power supply is cut off to the electromechanical actuator.

13. The motorized latch retraction assembly in accordance with claim 12 wherein the electromechanical actuator is a motor that does not back drive after moving the latch to the retracted position and power is cut off to the electromechanical actuator from the power supply.

14. The motorized latch retraction assembly in accordance with claim 13 further comprising a capacitor, wherein after the latch is moved to the retracted position and power is cut off to the electromechanical actuator from the power supply, the capacitor supplies power to the electromechanical actuator to move the latch to the extended position.

15. The motorized latch retraction assembly in accordance with claim 14 wherein the actuating assembly includes a biasing mechanism, and wherein a force imposed by the biasing mechanism along with the power provided by the capacitor operate to move the latch to the extended position after power is cut off to the electromechanical actuator from the power supply.

16. The motorized latch retraction assembly in accordance with claim 12 wherein the carrier link moves independently relative to the drive arm.

17-56. (canceled)
